(19) United States
(12) Patent Application Publication
(10) Pub. No.: US 2022/0057740 A1
(43) Pub. Date: Feb. 24, 2022

(54) IMAGE FORMING APPARATUS AND RECORDING MEDIUM

(71) Applicant: Konica Minolta, Inc., Tokyo (JP)

(72) Inventor: Sayaka Morita, Gamagori-shi (JP)

(73) Assignee: Konica Minolta, Inc., Tokyo (JP)

(21) Appl. No.: 17/407,994

(22) Filed: Aug. 20, 2021

(30) Foreign Application Priority Data
Aug. 21, 2020 (JP) 2020-139822

(51) Int. Cl. G03G 15/00; G03G 15/09

(52) U.S. Cl. CPC G03G 15/751; G03G 15/0907; G03G 15/5054

(57) ABSTRACT

An image forming apparatus is operable in a normal image forming mode and an uneven lubrication detecting mode, and includes: an image carrier; a lubricant applying device that applies lubricant to the image carrier; and a processor that detects uneven lubrication on a surface of the image carrier in the uneven lubrication detecting mode in which an amount of the lubricant applied to the image carrier is increased to exceed an amount of the lubricant applied in image forming.

### CROSS-REFERENCE TO RELATED APPLICATIONS

This application claims priority from Japanese Patent Application No. 2020-139822 filed on Aug. 21, 2020, the contents of which are incorporated herein by reference in its entirety.

### BACKGROUND

### Technical Field

The present invention relates to: an image forming apparatus such as a copier, a printer, a facsimile device, or a multifunctional apparatus having functions of the preceding multiple devices; and a recording medium.

### Description of the Related Art

It is known that, an image forming apparatus as mentioned above, particularly, an image forming apparatus using an electrophotographic method as a printing method, applies lubricant to the surface of a photoconductor as an image carrier. Lubricant serves to reduce the coefficient of friction of the surface of the photoconductor, thus lighten the load on the photoconductor and a cleaning device. Lubricant further serves to increase the efficiency of toner transfer and protect the photoconductor from corona products.

When a solid lubricant is used, a lubricant applying device, carrying this solid lubricant, takes some of the lubricant by scraping and applies it to the photoconductor.

However, external additives for toner can escape the cleaning device and adhere to a contact part of the lubricant applying device with the photoconductor. This will make it hard to take some of the lubricant, leading to a local difference in the amount of the applied lubricant, i.e., uneven lubrication. Uneven lubrication brings streaky image noise (density unevenness) and reduce image quality. So, it is necessary to detect, at an early stage, an uneven coating of lubricant, i.e., uneven lubrication.

Uneven lubrication is greatly affected by the circumstances when the lubricant is used, and can occur even before the end of a product life of the lubricant applying device. This means, image noise can increase to an unacceptable level even when a sufficient amount of lubricant still remains. In this case, the lubricant applying device needs replacement even before the end of its product life.

Alternatively, in order to prevent uneven lubrication, the lubricant applying device can be designed to take a sufficient amount of lubricant with respect to the external additives for toner adhering to the lubricant applying device itself. However, this means more consumption of lubricant, conflicting with conservation of lubricant.

Japanese Unexamined Patent Application Publication No. 2016-075777 suggests an image forming apparatus that is capable of eliminating uneven lubrication on a surface of the photoconductor and preventing streaks in an image, which is caused by the uneven lubrication. The image forming apparatus is provided with: an image carrier that carries toner; a supplying portion that supplies lubricant onto the image carrier; a lubricant amount detecting portion that detects, on the image carrier supplied with the lubricant by the supplying portion, an amount of the lubricant in a direction perpendicular to a conveyance direction for a recording material; a lubricant removing portion that removes the lubricant supplied on the image carrier; and a control portion that makes the lubricant removing portion remove the lubricant supplied on the image carrier when the lubricant amount detecting portion judges that there is uneven lubrication on the image carrier in the direction perpendicular to the conveyance direction for the recording material.

Japanese Unexamined Patent Application Publication No. 2016-024451 suggests an image forming apparatus that is capable of detecting, by a simplified methodology, a quantitative distribution of lubricant on an image carrier in an axial direction of the image carrier. The image forming apparatus is provided with: an image carrier; a latent image forming portion that forms an electrostatic latent image on the image carrier; a developing portion that forms a toner image on the image carrier; and a cleaning portion that removes toner remaining on the image carrier; the electrostatic latent image forming portion, the developing portion, and the cleaning portion are arranged around the image carrier in a rotational direction of the image carrier, and lubricant to be charged with an electrical charge having a polarity opposite to a polarity of the charged toner is supplied onto the image carrier. The image forming apparatus is further provided with: a triboelectric charging member that extends in an axial direction of the image carrier between the cleaning portion and the developing portion and that triboelectrically charges the image carrier in contact with the image carrier; and a surface potential measurement portion that extends in the axial direction and measures a surface potential distribution in the axial direction of the image carrier. The triboelectric charging member and the surface potential measurement portion are arranged in this order in the rotational direction, and thereby the surface potential distribution is measured after the image carrier is triboelectrically charged.

However, the image forming apparatus described in Japanese Unexamined Patent Application Publication No. 2016-075777 is not capable of detecting uneven lubrication at an early stage because of its poor sensitivity in detecting the uneven lubrication.

Furthermore, the image forming apparatus described in Japanese Unexamined Patent Application Publication No. 2016-024451 is not capable of detecting uneven lubrication at an early stage because of its low resolution in measuring a surface potential distribution.

### SUMMARY

One or more embodiments of the present invention, which have been made in consideration of such a technical background as described above, relate to an image forming apparatus that is capable of accurately detecting uneven lubrication on a surface of an image carrier at an early stage; and a recording medium.

One or more embodiments of the present invention relate to an image forming apparatus that is operable in a normal image forming mode and an uneven lubrication detecting mode, the image forming apparatus including:

an image carrier;

a lubricant applying portion (i.e., lubricant applying device) configured to apply lubricant to the image carrier; and

a processor configured to detect uneven lubrication on a surface of the image carrier in the uneven lubrication detecting mode in which an amount of the lubricant applied to the image carrier by the lubricant applying portion is increased to exceed an amount of the lubricant applied in image forming.

One or more embodiments of the present invention relate to a non-transitory computer-readable recording medium storing instructions for a computer of an image forming apparatus having an uneven lubrication detecting mode, the image forming apparatus including: an image carrier; and a lubricant applying portion configured to apply lubricant to the image carrier, the instructions causing the computer to execute:

increasing an amount of the lubricant applied to the image carrier by the lubricant applying portion to more in the uneven lubrication detecting mode than in image forming; and

detecting uneven lubrication on a surface of the image carrier in a condition in which the amount of the lubricant applied to the image carrier is increased to be greater than an amount of the lubricant applied in image forming.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a cross-sectional view illustrating a substantial part of an electrophotographic image forming apparatus according to one or more embodiments of the present invention.

FIG. 2 is a view illustrating a configuration of a lubricant applying device.

FIG. 3A and FIG. 3B indicate a relationship between the percentage of lubricant supply and the amount of lubricant on a surface of an image carrier.

FIG. 4 indicates a relationship between the percentage of lubricant supply and the amount of lubricant on the surface of the image carrier in an uneven lubrication detecting mode.

FIG. 5 is a flowchart for reference in describing an operation of the image forming apparatus in the uneven lubrication detecting mode.

### DETAILED DESCRIPTION OF EMBODIMENTS

Hereinafter, embodiments of the present invention will be described with reference to the drawings. However, the scope of the invention is not limited to the disclosed embodiments.

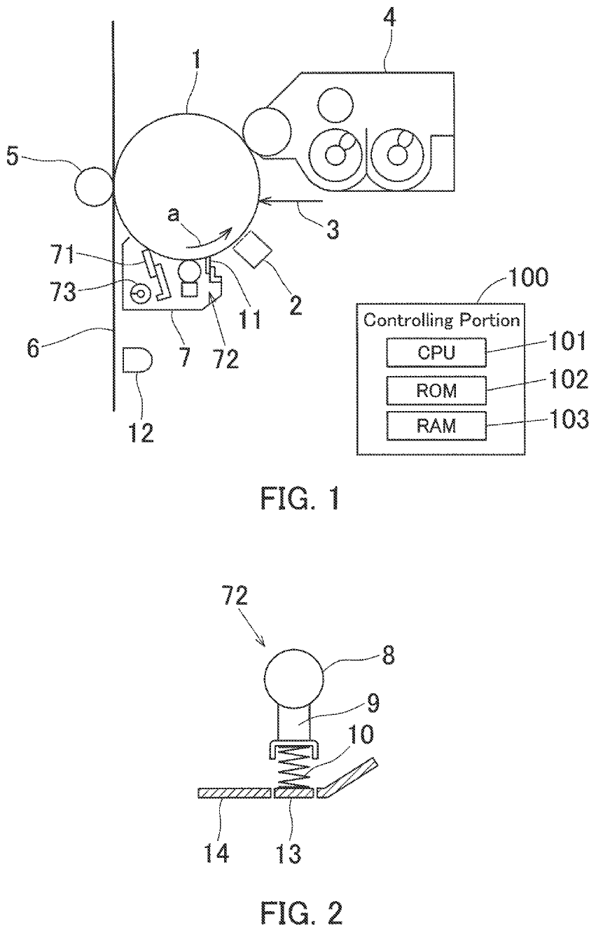

FIG. 1 is a cross-sectional view illustrating a substantial part of an electrophotographic image forming apparatus according to one or more embodiments of the present invention.

In FIG. 1, a photosensitive drum 1 is an image carrier to be coated with a lubricant. The photosensitive drum 1 rotates in a direction indicated by an arrow A. In the rotational direction, the photosensitive drum 1 is surrounded by: a charging portion 2; a luminous portion 3; a developing portion 4 (i.e., developing device); a transfer portion that is composed of a primary transfer member 5, an intermediate transfer belt (i.e., intermediate transfer body) 6, and the like; and a cleaning portion 7, which are components of the image forming apparatus.

The intermediate transfer belt 6 moves running in a downward direction of the page of FIG. 1. A density sensor 12 that measures the density of an image is disposed to face a surface (toner-receiving surface) of the intermediate transfer belt 6 at a position forward from the primary transfer member 5 in a direction in which the intermediate transfer belt 6 moves. The density sensor 12 extends from end to end of the intermediate transfer belt 6 in a direction (direction CD) perpendicular to the direction in which the intermediate transfer belt 6 moves.

The cleaning portion 7 is essentially composed of: a cleaning blade 71 to be in contact with the photosensitive drum 1; a lubricant applying device 72; a conveyance screw 73 that conveys removed toner out of the cleaning portion 7; and the like.

In the image forming apparatus shown in FIG. 1, the charging portion 2 charges a surface of the photosensitive drum 1, and the luminous portion 3 forms an electrostatic latent image on the charged surface of the photosensitive drum 1 by emitting light in accordance with image data. After that, the developing portion 4 develops an image (toner image) on the surface of the photosensitive drum 1.

In one or more embodiments, the image forming apparatus has a normal image forming mode and an uneven lubrication detecting mode. In the image forming mode, the primary transfer member 5 performs a primary transfer process, i.e., transfers the image, which is formed on the photosensitive drum 1, onto the intermediate transfer belt 6 in a primary transfer process. The intermediate transfer belt 6 conveys the image, which is transferred onto the intermediate transfer belt 6 in the primary transfer process, to a secondary transfer position (not shown). At the secondary transfer position, a secondary transfer member transfers the image onto paper (sheet). A fusing device bonds the image, which is transferred onto the paper, to the paper. The paper is then discharged from the image forming apparatus.

After the image is transferred onto the intermediate transfer belt 6, the cleaning blade 71 of the cleaning portion 7 removes toner remaining on the photosensitive drum 1. The conveyance screw 73 conveys the removed toner out of the cleaning portion 7. After the remaining toner is removed, the lubricant applying device 72 applies a lubricant to the surface of the photosensitive drum 1.

As illustrated in FIG. 2, the lubricant applying device 72 is provided with: a lubricant applying brush 8 that is a lubricant applying member; a solid lubricant 9; a compressing spring 10; and a smoothing member 11 (shown in FIG. 1). The lubricant 9 is disposed below the lubricant applying brush 8 in a state of being compressed upward by the compressing spring 10 and thereby brought into pressure contact with a lower region of the lubricant applying brush 8; lubricant is thus supplied to the lubricant applying brush 8. The lubricant applying brush 8 and the lubricant 9 extend from end to end of the photosensitive drum 1 in an axial direction of the photosensitive drum 1.

The lubricant applying brush 8 is composed of a roller having a brush on its surface, which is to be rotationally driven by a driving portion (not shown) such as a motor. The lubricant applying brush 8 is in contact with the surface of the photosensitive drum 1. The roller of the lubricant applying brush 8 is rotated in response to the rotation of the photosensitive drum 1. Being rotated, the lubricant applying brush 8 takes some of the lubricant 9 and applies it to the surface of the photosensitive drum 1. The lubricant applying member may be a lubricant applying roller instead of a lubricant applying brush.

Lubricant serves to reduce the coefficient of friction of the surface of the photosensitive drum 1, thus lighten the load on the photosensitive drum 1 and the cleaning device. Lubricant further serves to increase the efficiency of toner transfer and protect the photosensitive drum 1 from corona products.

The smoothing member 11 serves to smooth out the lubricant applied to the surface of the photosensitive drum 1. Meanwhile, a lower end of the compressing spring 10 is fixed on a cover 13 to be attached to a housing 14.

The image forming apparatus is provided with a control portion (i.e., processor or computer) 100. The control portion 100 is provided with: a CPU 101; a ROM 102 that stores operation instructions for the CPU 101 and other data; and a RAM 103 that serves as a workspace for the CPU 101 when the CPU 101 is in operation. The control portion 100 controls the image forming apparatus in a unified and systematic manner by operating in accordance with the operation instructions stored on a non-transitory computer-readable recording medium such as the ROM 102.

Specifically, the control portion 100 controls an image forming operation by an image forming portion. The image forming portion is composed of members related to image forming, for example: the photosensitive drum 1; the charging portion 2; the luminous portion 3; the developing portion 4; the primary transfer member 5; the intermediate transfer belt 6; the cleaning portion 7; and the secondary transfer member (not shown).

Furthermore, the control portion 100 changes the amount of lubricant applied to the photosensitive drum 1 by the lubricant applying device 72, estimates density unevenness of an image from the density of the image, which is measured by the density sensor 12, detects uneven lubrication on the photosensitive drum 1 with reference to (i.e., based on) the density unevenness, and performs various operations such as judging and control operations depending on the presence or absence of uneven lubrication. These operations will be later described in detail.

[Concept of Detecting Uneven Lubrication]

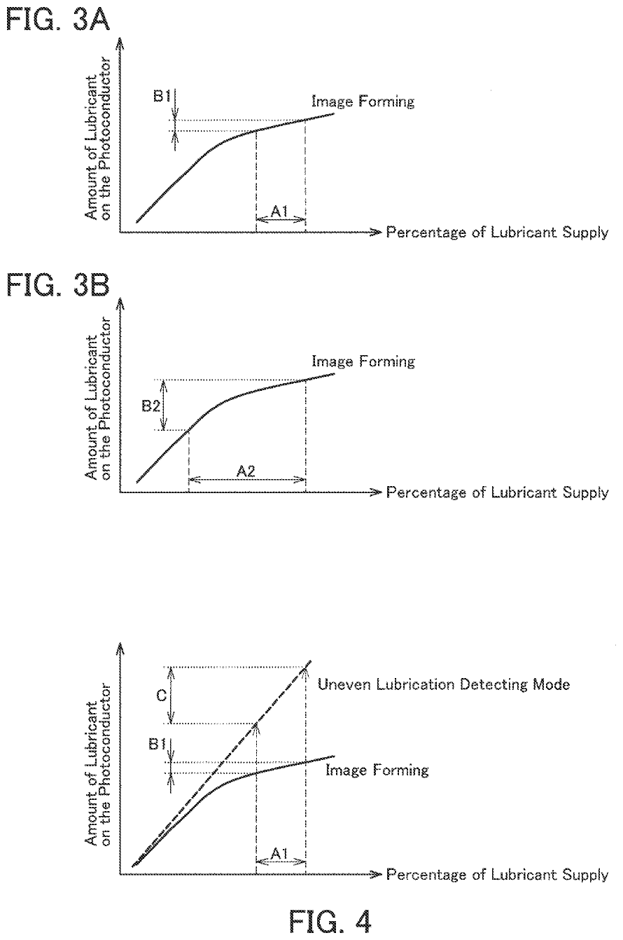

The image forming apparatus provided with the lubricant applying device 72 stores a relationship between the percentage of lubricant supply and the amount of lubricant on the surface of the photosensitive drum 1 as shown in FIG. 3A. In FIG. 3A, a horizontal axis represents the percentage of the lubricant supply, and a vertical axis represents the amount of the lubricant on the surface of the photosensitive drum 1.

In other words, the amount of the lubricant on the photosensitive drum 1 that is an image carrier is determined by a relationship between the amount of the lubricant supply from the lubricant applying device 72 and the amount of the lubricant removed by the smoothing member 11, the developing portion 4, the intermediate transfer belt 6, and the cleaning portion 7. The amount of the removed lubricant tends to be small in a range in which the percentage of the lubricant supply is low, and large in a range in which the percentage of the lubricant supply is high.

Referring to FIG. 3A, when the amount of the lubricant supply is large in image forming (in the image forming mode), the rate of increase in the amount of the lubricant on the photosensitive drum 1 tends to be slow. The percentage of the lubricant supply referred to herein means the amount of lubricant supplied from the lubricant applying device 72 with respect to the distance the photosensitive drum 1 travels.

Furthermore, in image forming, the amount of the lubricant supply will be set to fall within a range in which the rate of the increase is slow, in order to curtail unevenness in the amount of the lubricant on the photosensitive drum 1. For example, when there is an inconstancy in the amount of the lubricant supply in a horizontal axial direction (as indicated by an arrow Al), the unevenness in the amount of the lubricant on the photosensitive drum 1 (as indicated by an arrow B1) is so slight that it will not be detected as image noise.

Meanwhile, more and more external additives for toner adhere to a contact part of the lubricant applying brush 8 of the lubricant applying device 72 with the photosensitive drum 1, leading to contamination of the lubricant applying device 72. This will cause a reduction in the amount of the lubricant that the lubricant applying device 72 can apply.

Referring to FIG. 3B, contamination of the lubricant applying device 72 can grow to a certain degree and cause a reduction in the amount of the lubricant supply, for example. When there is an inconstancy in the amount of the lubricant supply in the horizontal axial direction (as indicated by an arrow A2), the unevenness in the amount of the lubricant on the photosensitive drum 1 (as indicated by an arrow B2) will be successfully detected. However, the inconstancy in the amount of the lubricant supply cannot be easily eliminated because of the adhered contaminants which cannot be easily removed.

For this reason, it is necessary to detect a condition in which the lubricant applying device 72 has few contaminants on itself, i.e., a condition in which the contaminants cause only a small reduction in the amount of the lubricant supply and the inconstancy in the amount of the lubricant supply (uneven lubrication) is slight.

In one or more embodiments, as indicated in FIG. 4, when the percentage of the lubricant supply is high in the uneven lubrication detecting mode, the amount of the lubricant on the photosensitive drum 1 is increased. That is, the unevenness in the amount of the lubricant on the photosensitive drum 1, which is caused by the inconstancy in the amount of the lubricant supply, is increased. Such an increase allows successfully detecting the inconstancy in the amount of the lubricant supply, i.e., uneven lubrication.

When the percentage of the lubricant supply is high as described above, the amount of the lubricant on the photosensitive drum 1 is increased by reducing the effect of removing the lubricant, namely, reducing an amount of a removed lubricant.

[Reducing the Effect of Removing the Lubricant]

The reduction in the effect of removing the lubricant is achieved by a reduction in the effect of removing the lubricant by at least one of the smoothing member 11, the developing portion 4, the intermediate transfer belt 6, and the cleaning portion 7.

The effect of removing the lubricant by the developing portion 4 is reduced by regulating the distance between the developing portion 4 and the photosensitive drum 1 or by regulating the developing bias applied to the developing portion 4.

Specifically, the effect of removing the lubricant is reduced by regulating the distance between the developing portion 4 and the photosensitive drum 1, which is making the distance longer than in image forming (0.3 mm in image forming, 0.5 mm in the uneven lubrication detecting mode, for example).

The effect of removing the lubricant is reduced by regulating the developing bias, which is reducing the absolute value of the bias between the developing portion 4 and the photosensitive drum 1 (−500V in image forming, 0V in the uneven lubrication detecting mode, for example). When alternating voltage is superimposed on the bias, it is reduced by reducing the frequency of the bias.

The effect of removing the lubricant by the intermediate transfer belt 6 is reduced by separating the intermediate transfer belt 6 from the photosensitive drum 1.

The reduction in the effect of removing the lubricant by the blade-shaped smoothing member 11 is achieved by reducing the pressure of the smoothing member 11 to the photosensitive drum 1 (5N in image forming, 1N in the uneven lubrication detecting mode, for example) or separating the smoothing member 11 from the photosensitive drum 1. Similarly, the reduction in the effect of removing the lubricant by the cleaning blade 71 of the cleaning portion 7 is achieved by reducing the pressure of the cleaning blade 71 to the photosensitive drum 1 (5N in image forming, 1N in the uneven lubrication detecting mode, for example) or separating the cleaning blade 71 from the photosensitive drum 1.

Alternatively, the effect of removing the lubricant is reduced by regulating the tangential angle of the smoothing member 11 with respect to the photosensitive drum 1 (15 degrees in image forming, 5 degrees in the uneven lubrication detecting mode, for example).

When the cleaning portion 7 is provided with a brush-like or roller-like cleaning member, instead of the cleaning blade 71, the effect of removing the lubricant is reduced by reducing the pressure of the cleaning member to the photosensitive drum 1 (2N in image forming, 1N in the uneven lubrication detecting mode, for example) or separating the cleaning member from the photosensitive drum 1. Alternatively, the effect of removing the lubricant is reduced by reducing the number of revolutions (1.5 in image forming, one in the uneven lubrication detecting mode, for example) or reducing the absolute value of the bias (−500V in image forming, 0V in the uneven lubrication detecting mode, for example).

[Regulating the Amount of the Lubricant on the Photosensitive Drum]

Regardless of whether the effect of removing the lubricant is reduced or not, the amount of the lubricant on the photosensitive drum 1 can be increased to more than in image forming (in printing). The amount of the lubricant on the photosensitive drum 1 is regulated by controlling the lubrication applying operation of the lubricant applying device 72 and the driving of the photosensitive drum 1.

Here is a concrete example thereof: the amount of the lubricant on the photosensitive drum 1 is increased by increasing the number of revolutions of the photosensitive drum 1 to more than one (to 10, for example). This will improve the sensitivity in detecting uneven lubrication.

For better conditions for detection, there may be two or more reference values of the speed ratio of the lubricant applying brush 8 of the lubricant applying device 72 to the photosensitive drum 1. For example, the amount of lubrication is increased by increasing the rotational speed of the lubricant applying brush 8 to more than in image forming (the speed ratio is 1.3 in image forming, 1.5 in the uneven lubrication detecting mode, for example). This will shorten the time required to detect uneven lubrication.

Furthermore, it is increased by reducing the speed of the lubricant applying brush 8 to lower than in image forming (the speed ratio is 1.1 in the uneven lubrication detecting mode, for example). This will allow detecting uneven lubrication even when it is imperceptible.

Alternatively, it is achieved by setting the number of revolutions of the lubricant applying brush 8 to an integral multiple of the number of revolutions of the photosensitive drum 1. This will allow detecting uneven lubrication in a rotational direction of the lubricant applying brush 8 or the lubricant applying roller.

[Detecting Uneven Lubrication]

<Timing for Judging about the Presence or Absence>

In the uneven lubrication detecting mode, the presence or absence of uneven lubrication may be judged every time a predetermined number of pages (50,000 pages, for example) have been printed. The time interval between judgments about the presence or absence may be lengthen or shortened. A shorter time interval between judgments about the presence or absence will enhance the capability of curtailing uneven lubrication.

Furthermore, the timing for judging about the presence or absence may be changed in accordance with the number of usable sheets. Specifically, in normal image forming, when the density unevenness is less than a reference value, a predetermined page count, which corresponds to the timing for judging about the presence or absence, may be increased (to 100,000 pages, for example) because uneven lubrication will not be detected soon at this point in time. When the density unevenness is greater than the reference value, the predetermined page count, which corresponds to the timing for judging about the presence or absence, may be reduced (to 10,000 pages, for example) because uneven lubrication will be detected soon at this point in time.

The timing for judging about the presence or absence of uneven lubrication may be changed depending on an environmental condition or page coverage. For example, the time interval between judgments about the presence or absence may be shortened under low temperature or at a high page coverage.

<Method of Detection>

One of the methods of detecting uneven lubrication is measuring density unevenness (varying degrees of density) of an image. In other words, uneven lubrication is detected by measuring density unevenness of an image because density unevenness occurs with uneven lubrication.

Specifically, in the uneven lubrication detecting mode in which the amount of the lubricant applied to the photosensitive drum 1 by the lubricant applying device 72 is increased to more than in image forming by the above-described method, a density unevenness mensurative image that is composed of a predetermined patterned image is formed on the photosensitive drum 1. Subsequently, the halftone image formed on the photosensitive drum 1 is transferred onto the intermediate transfer belt 6 in the first transfer process, thereby a density unevenness mensurative image is formed on the intermediate transfer belt 6. To measure density unevenness accurately, the density unevenness mensurative image may have 64 gradations when a solid image has 256 gradations.

The density unevenness mensurative image transferred on the intermediate transfer belt 6 in the first transfer process is conveyed by the intermediate transfer belt 6. When the density unevenness mensurative image passes the density sensor 12, the density of the density unevenness mensurative image is measured by the density sensor 12. With reference to the measured density, density unevenness is calculated by the control portion 100.

After measurement of the density, the density unevenness mensurative image formed on the intermediate transfer belt 6 may be removed without being transferred onto a sheet in a secondary transfer process. Furthermore, in one or more embodiments, the image forming apparatus is configured to measure the density of the density unevenness mensurative image formed on the intermediate transfer belt 6. Alternatively, it may measure the density of the density unevenness mensurative image formed on the photosensitive drum 1 and calculate density unevenness.

Additionally, the image forming apparatus may transfer the density unevenness mensurative image formed on the intermediate transfer belt 6 to a sheet in the secondary transfer process, fix the image to the sheet by a fusing device (not shown), measure the density of the unevenness mensurative image fixed to the sheet, and calculate density unevenness. The image forming apparatus may not measure the density of the density unevenness mensurative image and calculate density unevenness. Instead of the image forming apparatus, an external device connected thereto, such as an intelligent quality optimizing unit (e.g. IQ-501 manufactured by KONICA MINOLTA INC.) or a scanning device, may measure the density and/or calculate density unevenness after reading the density unevenness mensurative image fixed to the sheet, so that the image forming apparatus can receive a calculated result therefrom and detect uneven lubrication.

The image forming apparatus may be an image forming apparatus not provided with the intermediate transfer belt 6. In this case, it measures the density of the density unevenness mensurative image formed on the photosensitive drum 1 or transferred and fixed to the sheet, and calculates density unevenness.

The image forming apparatus may be a color image forming apparatus provided with a plurality of the photosensitive drums 1. In this case, it forms the density unevenness mensurative image in multicolor using the photosensitive drums 1 or in single color (black, for example) using one of the photosensitive drums 1.

The density sensor 12 measures the image density at multiple positions aligned in a direction CD perpendicular to a sheet passing direction (a direction in which the intermediate transfer belt 6 runs) and transfers the measured results to the control portion 100. The image density at each measurement position is calculated using the data measured multiple times in the sheet passing direction (direction FD). The CPU 101 of the control portion 100 calculates uneven lubrication by calculating a difference between measured values of density with reference to the measured results of density received from the density sensor 12. Specifically, the CPU 101 calculates a difference between the values of density measured at every two adjoining measurement positions aligned in the direction CD. The uneven lubrication is defined by the greatest one of all those differences. When the greatest one of all the differences is greater than a preset reference value, it is judged that uneven lubrication is present.

One of the methods of detecting uneven lubrication is measuring the reflectivity of the surface of the photosensitive drum 1.

Specifically, in the uneven lubrication detecting mode in which the amount of the lubricant applied to the photosensitive drum 1 by the lubricant applying device 72 is increased to more than in image forming by the above-described method, the reflectivity of the surface of the lubricant-coated photosensitive drum 1 is measured at multiple positions in an axial direction (direction CD) of the photosensitive drum 1, and the measured results are transferred to the control portion 100. The reflectivity at each measurement position is calculated using the data measured multiple times in a rotational direction of the photosensitive drum 1. The CPU 101 of the control portion 100 calculates uneven lubrication by calculating a difference between the measured values of reflectivity. Specifically, the CPU 101 calculates a difference between the values of reflectivity measured at every two adjoining measurement positions in the direction CD. The uneven lubrication is defined by the greatest one of all those differences. When the greatest one of all the differences is greater than a preset reference value, it is judged that uneven lubrication is present.

The method of measuring the reflectivity of the surface of the photosensitive drum 1 is a commonly known method. For example, the method described in Japanese Unexamined Patent Application Publication No. 2016-075777 may be used.

[Recovery Mode for Curtailing Uneven Lubrication]

In one or more embodiments, a recovery mode for curtailing uneven lubrication is implemented upon detection of uneven lubrication. In the recovery mode, the control portion 100 rotationally drives the photosensitive drum 1, the lubricant applying device 72 continues lubricant supply for a predetermined period of time in a non-image forming state, and the amount of the applied lubricant is thereby increased. The recovery mode may be enabled or disabled in advance such that it will be implemented or not upon detection of uneven lubrication; in this case, the recovery mode is implemented only when it is enabled in advance.

In the recovery mode, a non-toner image that is a solid white image may be used, or a toner image extending from end to end in the direction CD may be formed. The toner image may be a strip solid-colored image or a linear image only when the average page coverage is low.

In the recovery mode, the uneven lubrication is curtailed more quickly by increasing the linear velocity ratio of the lubricant applying brush 8 to the photosensitive drum 1 to greater than in normal (1.3 in normal, 1.4 in the recovery mode).

After curtailment of the uneven lubrication in the recovery mode, it is judged again in the uneven lubrication detecting mode whether or not uneven lubrication is present. This will ensure curtailment of the uneven lubrication.

[Uneven Lubrication Recovery Configuration]

Upon detection of uneven lubrication, curtailment of the uneven lubrication is started without interruption of printing by changing the setting from a condition of lubricant application, for example, to a condition of recovery. Furthermore, in an environment in which lubricant is more prone to uneven distribution or depending on page coverage, curtailment of the uneven lubrication is started without interruption of printing by changing the setting to the condition of recovery.

In the uneven lubrication recovery configuration, contaminants on the lubricant applying brush 8 are reduced and the capability of applying lubricant is restored, by changing the interval between consecutive sheets to longer in image forming. Additionally, contaminants on the lubricant applying brush 8 are reduced by changing the linear velocity ratio of the lubricant applying brush 8 to the photosensitive drum 1 to greater than in normal image forming. For example, under low temperature, the percentage of the lubricant supply is increased by increasing the linear velocity ratio, so that the contaminated lubricant will be adequately removed without interruption of image forming.

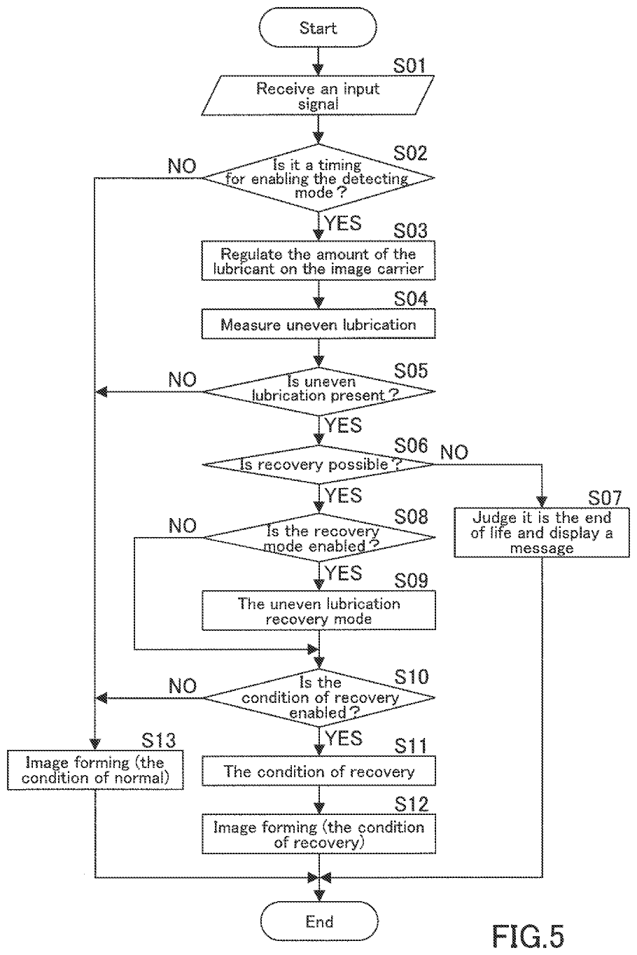

FIG. 5 is a flowchart representing an operation performed by the image forming apparatus in the uneven lubrication detecting mode. This operation is performed by the CPU 101 of the control portion 100 in accordance with an operation instruction stored on a recording medium such as the ROM 102.

In Step S01, an input image signal is received. In Step S02, it is judged whether or not it is a timing for enabling the uneven lubrication detecting mode. When it is not a timing for enabling the mode (NO in Step S02), the process proceeds to Step S13, in which image forming (printing) is performed in a normal fashion.

When it is a timing for enabling the mode (YES in Step S02), the amount of the lubricant on the photosensitive drum 1 is increased in Step S03. Subsequently, uneven lubrication is measured in Step S04.

In Step S05, it is judged whether or not uneven lubrication is present, by comparing the measured value to a predetermined reference value for uneven lubrication. When uneven lubrication is not present (NO in Step S05), image forming is performed in a normal fashion in Step S13. When uneven lubrication is present (YES in Step S05), the process proceeds to Step S06.

In Step S06, it is judged whether or not recovery is possible. Whether or not recovery is possible may be judged with reference to the degree of the uneven lubrication, a history of past events, or the like. When recovery is possible (YES in Step S06), the process proceeds to Step S08. When recovery is not possible (NO in Step S06), the process proceeds to Step S07, in which the lubricant applying device 72 is judged to have reached the end of its product life and a message requesting for replacement is displayed.

In Step S08, it is judged whether or not a recovery mode for curtailing uneven lubrication is enabled. When the recovery mode is enabled (YES in Step S08), the uneven lubrication recovery mode is implemented and a predetermined recovery process is performed in Step S09. Subsequently, the process proceeds to Step S10. Back to Step S08, when the recovery mode is not enabled (NO in Step S08), the process directly proceeds to Step S10.

In Step S10, it is judged whether or not the condition of recovery is enabled. When the condition of recovery is not enabled (NO in Step S10), image forming is performed in the condition of normal in Step S13. When the condition of recovery is enabled (YES in Step S10), the setting is changed from the condition of lubricant application, for example, to the condition of recovery in Step S11. Subsequently, image forming is performed in the changed condition in Step S12.

The following steps may be performed upon the uneven lubrication detecting mode being enabled: judging whether or not the recovery mode is enabled in Step S08; implementing the recovery mode in Step S09; judging whether or not the condition of recovery is enabled in Step S10; and changing the setting to the condition of recovery in Step S11. The present invention, however, should not be limited to this example. Printing starts after a delay in the recovery mode. To prevent the delay, it may be configured such that the recovery mode is not implemented depending on an environmental condition or page coverage. In this case, specifically, the recovery mode is not implemented when the page coverage of an input image is lower than a reference value (5%, for example) or when the ambient temperature is higher than a reference value (28° C., for example).

As described above, in one or more embodiments, uneven lubrication is detected in the uneven lubrication detecting mode in which the amount of the lubricant applied to the photosensitive drum 1 by the lubricant applying device 72 is increased to more than in image forming. This will improve the sensitivity in detecting uneven lubrication, resulting in accurately detecting uneven lubrication at an early stage.

Furthermore, when the uneven lubrication is detected in the uneven lubrication recovery mode, the linear velocity ratio of the lubricant applying brush 8 to the photosensitive drum 1 is increased, and the photosensitive drum 1 and the lubricant applying device 72 are driven in a non-image forming state. This will increase the amount of the lubricant applied to the photosensitive drum 1, resulting in preventing uneven lubrication.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus that is operable in a normal image forming mode and an uneven lubrication detecting mode, comprising:
an image carrier;
a lubricant applying device that applies lubricant to the image carrier; and
a processor that detects uneven lubrication on a surface of the image carrier in the uneven lubrication detecting mode in which an amount of the lubricant applied to the image carrier is increased to exceed an amount of the lubricant applied in image forming.

2. The image forming apparatus according to claim 1, wherein the amount of the lubricant applied to the image carrier is increased by reducing an amount of a removed lubricant.

3. The image forming apparatus according to claim 2, further comprising
a developing device; and
an intermediate transfer body, wherein
the amount of the removed lubricant is reduced by the developing device or the intermediate transfer body.

4. The image forming apparatus according to claim 3, wherein the amount of the removed lubricant is reduced by at least one of:
increasing a distance between the developing device and the image carrier;
reducing an absolute value of a developing bias of the developing device; and
separating the intermediate transfer body from the image carrier.

5. The image forming apparatus according to claim 2, wherein
the processor rotationally drives the image carrier,
the lubricant applying device comprises a rotatable lubricant applying member that contacts the image carrier and applies the lubricant, and
the amount of the lubricant applied to the image carrier is increased when the processor drives the image carrier to rotate more than once.

6. The image forming apparatus according claim 1, wherein the processor detects the uneven lubrication by measuring a reflectivity of the surface of the image carrier.

7. The image forming apparatus according to claim 1, wherein
in the uneven lubrication detecting mode, the processor detects the uneven lubrication based on density unevenness measured from a first density unevenness mensurative image or a second density unevenness mensurative image,
the first density unevenness mensurative image is formed on the image carrier, and
the second density unevenness mensurative image is obtained by transferring the first density unevenness mensurative image one or more times.

8. The image forming apparatus according to claim 1, wherein the image forming apparatus is operable in an uneven lubrication recovery mode where the processor curtails the uneven lubrication upon detecting the uneven lubrication.

9. The image forming apparatus according to claim 8, wherein
the lubricant applying device comprises a rotatable lubricant applying member that contacts the image carrier and applies the lubricant, and
the processor increases a linear velocity ratio of the lubricant applying member to the image carrier in the uneven lubrication recovery mode.

10. The image forming apparatus according to claim 8, wherein the processor drives the image carrier and the lubricant applying device in a non-image forming state in the uneven lubrication recovery mode.

11. A non-transitory computer-readable recording medium storing instructions for a computer of an image forming apparatus that is operable in a normal image forming mode and an uneven lubrication detecting mode and that comprises: an image carrier; and a lubricant applying device that applies lubricant to the image carrier, the instructions causing the computer to execute:
in the uneven lubrication detecting mode,
increasing an amount of the lubricant applied to the image carrier to exceed an amount of the lubricant applied in image forming; and
detecting uneven lubrication on a surface of the image carrier in a condition that the amount of the lubricant applied to the image carrier exceeds the amount of the lubricant applied in image forming.

12. The non-transitory computer-readable recording medium according to claim 11, wherein the instructions further cause the computer to execute:
increasing the amount of the lubricant applied to the image carrier by reducing an amount of a removed lubricant.

13. The non-transitory computer-readable recording medium according to claim 12, wherein the image forming apparatus further comprising:
a developing device; and
an intermediate transfer body, and
the instructions further cause the computer to execute:
reducing the amount of the removed lubricant by the developing device or the intermediate transfer body.

14. The non-transitory computer-readable recording medium according to claim 13, wherein the instructions further cause the computer to execute:
reducing the amount of the removed lubricant by at least one of:
increasing a distance between the developing device and the image carrier;
reducing an absolute value of a developing bias of the developing device; and
separating the intermediate transfer body from the image carrier.

15. The non-transitory computer-readable recording medium according to claim 12, wherein
the lubricant applying device comprises a rotatable lubricant applying member that contacts the image carrier and applies the lubricant,
the instructions further cause the computer to execute:
rotationally driving the image carrier, and
increasing the amount of the lubricant applied to the image carrier by driving the image carrier to rotate more than once.

16. The non-transitory computer-readable recording medium according to claim 11, wherein the instructions further cause the computer to execute:
detecting the uneven lubrication by measuring a reflectivity of the surface of the image carrier.

17. The non-transitory computer-readable recording medium according to claim 11, wherein the instructions further cause the computer to execute:
in the uneven lubrication detecting mode, detecting the uneven lubrication based on density unevenness measured from a first density unevenness mensurative image or a
second density unevenness mensurative image, wherein
the first density unevenness mensurative image is formed on the image carrier, and
the second density unevenness mensurative image is obtained by transferring the first density unevenness mensurative image one or more times.

18. The non-transitory computer-readable recording medium according to claim 11, wherein the image forming apparatus is operable in an uneven lubrication recovery mode where the uneven lubrication is curtailed upon detection of the uneven lubrication.

19. The non-transitory computer-readable recording medium according to claim 18, wherein
the lubricant applying device comprises a rotatable lubricant applying member that contacts the image carrier and applies the lubricant, and
the instructions further cause the computer to execute:
increasing a linear velocity ratio of the lubricant applying member to the image carrier in the uneven lubrication recovery mode.

20. The non-transitory computer-readable recording medium according to claim 18, wherein the instructions further cause the computer to execute:
driving the image carrier and the lubricant applying device in a non-image forming state in the uneven lubrication recovery mode.
